(19) United States
(12) Patent Application Publication
(10) Pub. No.: US 2011/0019226 A1
(43) Pub. Date: Jan. 27, 2011

(54) SERVER, PRINTER, AND COMPUTER READABLE MEDIUM

(75) Inventor: Shohei TSUJIMOTO, Kuwana-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/727,569

(22) Filed: Mar. 19, 2010

(30) Foreign Application Priority Data
Jul. 22, 2009 (JP) 2009-171414

(51) Int. Cl. G06F 3/12

(52) U.S. Cl. 358/1.15

(57) ABSTRACT

A first server is connectable to a communication device and a second server via a network. The first server includes: a conversion unit; a print data supply unit; a determination unit and an application data supply unit. In a first case where the determination unit determines that the conversion unit can convert specific application data, the conversion unit converts the specific application data into specific print data, and the print data supply unit supplies the specific print data to the print unit. In a second case where the determination unit determines that the conversion unit cannot convert the specific application data, the application data supply unit supplies the specific application data to the second server that can convert the specific application data.

### CROSS REFERENCE TO RELATED APPLICATION

The present disclosure relates to the subject matter contained in Japanese patent application No. 2009-171414 filed on Jul. 22, 2009, which is expressly incorporated herein by reference in its entirety.

### TECHNICAL FIELD

The present disclosure relates to a server capable of converting application data into print data.

### BACKGROUND ART

JP-A-11-15610 discloses a server connected to a communication device via a network. When the server is instructed to print an image, which is indicated by application data generated by an application program, by the communication device, the server converts the application data into print data using a conversion program corresponding to the type of the instructed application data.

The server disclosed in JP-A-11-15610 cannot convert a predetermined type of application data, which does not correspond to its conversion program, into print data. Accordingly, even when the server is instructed to print the predetermined type of application data, the server cannot print the application data.

JP-A-11-15610 discloses a printer that is connected to a host, such as a PC, and that does not use a printer driver. The printer prints, without using a printer driver, print data generated by the host. JP-A-2008-243029 discloses a print system including a host, such as a PC, and a printer. The printer prints XPS document data output from the host.

### SUMMARY

The present disclosure can provide, as an illustrative, non-limiting embodiment, a first server connectable to a communication device and a second server via a network. The first server includes: a conversion unit configured to convert application data generated by an application program into print data that can be interpreted by a printing unit; a print data supply unit configured to supply the print data to the printing unit; and a determination unit configured to, if the first server is instructed by the communication device to print an image indicated by specific application data generated by a specific application program, determine whether the conversion unit can convert the specific application data. In a first case where the determination unit determines that the conversion unit can convert the specific application data, the conversion unit converts the specific application data into specific print data, and the print data supply unit supplies the specific print data to the print unit. The first server further includes: an application data supply unit configured to, in a second case where the determination unit determines that the conversion unit cannot convert the specific application data, supply the specific application data to the second server that can convert the specific application data.

Accordingly, as one of advantages, a technique capable of converting application data into print data is provided even when a server instructed to print an image cannot convert the application data into the print data.

A printer including the first server and the printing unit can be provided usefully. The technique described in this specification can be expressed in various aspects. For example, it may be expressed as a control method of implementing the first server, a computer program, and a recording medium having the computer program recorded thereon. A system including the first server, the second server, and the communication device can be provided usefully.

The above-mentioned advantage and other advantages will be discussed in detail with reference to the accompanying drawings.

### BRIEF DESCRIPTION OF THE DRAWINGS

FIG. 1 is a diagram illustrating the configuration of a communication system.

FIG. 2 is a flowchart illustrating a flow of processes in a PC, a first printer, and a second printer according to a first embodiment.

FIG. 3 is a flowchart illustrating a flow of processes in a PC, a first printer, and a second printer according to a second embodiment.

FIG. 4 is a flowchart illustrating a flow of processes in a PC, a first printer, and a second printer according to a third embodiment.

### DESCRIPTION OF THE PREFERRED EMBODIMENT

### First Embodiment

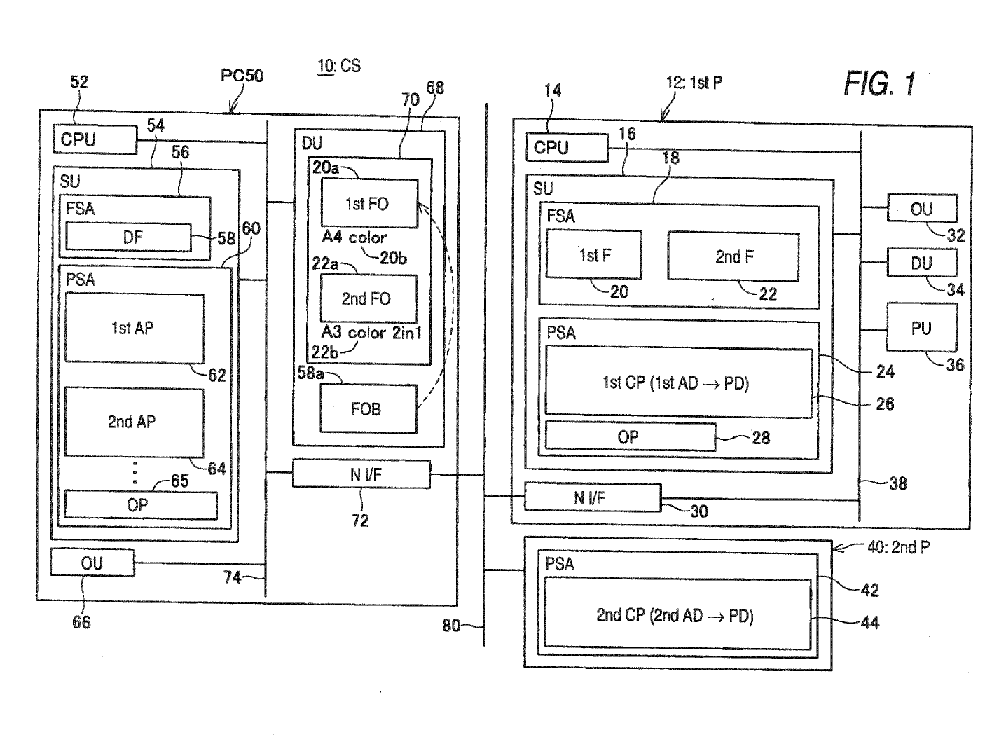

A first embodiment will be described with reference to the accompanying drawings. FIG. 1 is a diagram illustrating the configuration of a communication system 10 according to this embodiment. The communication system 10 includes a first printer 12, a second printer 40, a PC 50, and a LAN 80. The devices 12, 40, and 50 are connected to the LAN 80. The devices 12, 40, and 50 can communicate with each other via the LAN 80. The number of PCs and the number of printers in the communication system 10 are not particularly limited.

### Configuration of PC

As shown in FIG. 1, the PC 50 includes a CPU 52, a storage unit 54, an operation unit 66, a display unit 68, and a network interface 72 (referred to as “network I/F 72” in FIG. 1 and in the below description). The units 52, 54, 66, 68, and 72 are connected to a bus 74. The network I/F 72 is connected to the LAN 80.

The CPU 52 controls the units 54 and 68. The CPU 52 performs a variety of processes in accordance with various programs 62, 64, and 65 stored in a program storage area 60 of the storage unit 54.

The storage unit 54 includes a file storage area 56 and a program storage area 60. Plural types of application programs 62 and 64 (for example, word processor software, spread sheet software, and drawing software) are stored in the program storage area 60. For example, a user of the PC 50 can execute a first-type application program 62 by the use of the operation unit 66, whereby application data corresponding to the first-type application program 62 can be generated. Hereinafter, the application data corresponding to the first-type application program 62 is referred to as first type application data, and the application data corresponding to a second-type application program 64 is referred to as second type application data. A program 65 other than the application programs 62 and 64 is stored in the program storage area 60.

The file storage area 56 can store a data file 58, The application data generated by the application program is described in the data file 58. Hereinafter, the application data described in the data file 58 is referred to as application data 58. The data file 58 may be an application data file generated by the application program 62, 64 stored in the program storage area 60 or an application data file generated by an application program other than application programs stored in the program storage area 60. For example, the data file may be a data file downloaded from the Internet.

The operation unit 66 includes a keyboard and a mouse. The user causes the PC 50 to perform various processes by operating the operation unit 66.

The display unit 68 can display a variety of information. A user causes the display unit 68 to display a file object 58a corresponding to the data file 58 stored in the file storage area 56 by operating the operation unit 66. The user can access plural shared folders 20 and 22 (folders to which the access of another device is permitted) stored in the first printer 12 by operating the operation unit 66. When this operation is performed, a window 70 is displayed on the display unit 68. The window 70 is used for the PC 50 to instruct the first printer 12 to perform a printing operation. Folder objects 20a and 22a corresponding to the folders 20 and 22 stored in the first printer 12 are displayed in the window 70. The first folder object 20a and the second folder object 22a correspond to a first folder 20 and a second folder 22 of the first printer 12 to be described later.

For example, when the user drags and drops a file object 58a into the first folder object 20a by operating the operation unit 66, the data file 58 is stored in the first folder 20 of the first printer 12. The first printer 12 performs a process of printing a color image represented by the data file 58 on an A4-size sheet. A folder name 20b “A4 color” indicating that the first printer 12 prints a color image on an A4-size sheet is displayed in the vicinity of the folder object 20a. For example, when the user drops the file object 58a into the second folder object 22a, the data file 58 is stored in the second folder 22 of the first printer 12. The first printer 12 performs a process of printing two pages of color images represented by the data file 58 on one A3-size sheet. A folder name 22b “A3 color 2in1” indicating that the first printer 12 prints two pages of color images included in the application data on one A3-size sheet is displayed in the vicinity of the folder object 22a.

### Configuration of First Printer

As shown in FIG. 1, the first printer 12 includes a CPU 14, a storage unit 16, a network interface 30 (referred to as “network I/F 30” in FIG. 1 and the following description), an operation unit 32, a display unit 34, and a print unit 36. The units 14, 16, 30, 32, 34, and 36 are connected to a bus 38. The network I/F 30 is connected to a LAN 80.

The CPU 14 controls the units 16, 34, and 36. The CPU 14 performs various processes on the basis of programs stored in a program storage area 24 of the storage unit 16.

The storage unit 16 includes a folder storage area 18 and a program storage area 24. Plural folders 20 and 22 are stored in a folder storage area 18. The folders 20 and 22 stored in the folder storage area 18 are prepared in advance. When the data file 58 is stored in the first folder 20, the first printer 12 performs a process of printing a color image on an A4-size sheet. When the data file 58 is stored in the second folder 22, the first printer 12 performs a process of printing two pages of color images on one A3-size sheet.

A first-type conversion program 26 and other programs 28 are stored in the program storage area 24. The first-type conversion program 26 is a program for converting first-type application data generated by the first-type application program into print data (for example, PDL (Page Description Language) data). In this embodiment, the first-type conversion program 26 is the same program as the first-type application program 62 stored in the PC 50. A conversion program for converting second-type application generated by a second-type application program into print data is not stored in the program storage area 24. That is, the first printer 12 cannot convert the second-type application data into print data. The programs 28 include a program for causing the CPU 14 to perform processes other than the conversion process.

The operation unit 32 includes plural keys such as numerical key pads or a start key. A user can cause the first printer 12 to perform various processes by operating the operation unit 32. The display unit 34 can display a variety of information. The print unit 36 performs a printing operation on a printing medium on the basis of the print data supplied from the CPU 14. The print unit 36 can interpret the print data converted from the first-type application data by the first-type conversion program 26 and can also interpret the print data converted from the second-type application data by a second-type conversion program 44 to be described later.

The second printer 40 has the same configuration as the first printer 12. The second printer 40 stores a second-type conversion program 44 for converting second-type application data generated by the second-type application program into print data (such as PDL data). In this embodiment, the second-type conversion program 44 is the same program as the second-type application program 64 stored in the PC 50. Similarly to the print unit 36 of the first printer 12, the print unit of the second printer 40 can interpret the print data converted from the first-type application data by the first-type conversion program 26 and can also interpret the print data converted from the second-type application data by the second-type conversion program 44.

### Processes in Devices

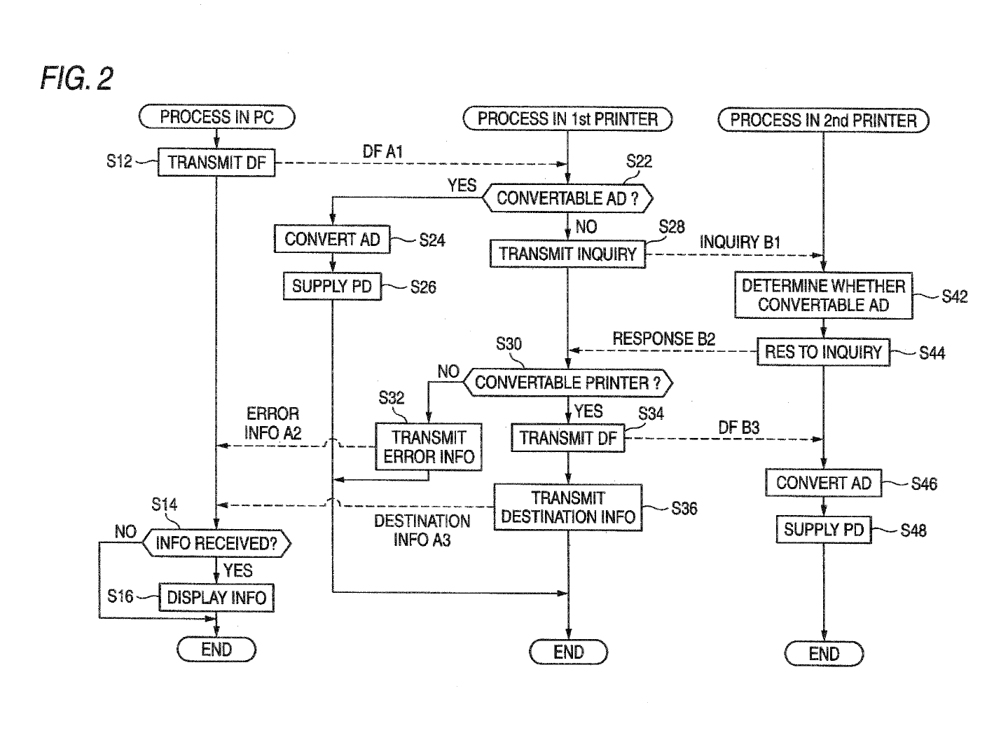

Processes performed by the devices 12, 40, and 50 will be described. FIG. 2 is a flowchart illustrating flows of processes performed by the devices 12, 40, and 50. The broken arrows in FIG. 2 indicate transmission directions of data or information between the devices 12, 40, and 50. The directions of the solid arrows indicate the transmission directions of data or information.

As described above, the user can display the folder objects 20a and 22a corresponding to the folders 20 and 22 stored in the folder storage area 18 of the first printer 12 on the window 70 by operating the operation unit 66 of the PC 50. The user can copy the file object 58a to a folder (for example, 20) of the first printer 12 by dragging and dropping the file object 58a into one folder object (for example, 20a). Accordingly, the flows of the processes shown in FIG. 2 are started.

The CPU 52 of the PC 50 transmits the data file 58 (A1) corresponding to the file object 58a to the first printer 12 (S12). In S12, the folder name corresponding to the folder object in which the file object 58a is stored is also transmitted.

When receiving the data file 58 (A1), the CPU 14 of the first printer 12 stores the data file 58 in the folder (for example, the first folder 20) with the folder name transmitted from the PC 50. When receiving the data file 58 (A1) from the PC 50, the CPU 14 determines that a print instruction is transmitted from the PC 50. The CPU 14 determines whether the application data 58 can be converted into print data (S22). When the application data 58 is the first-type application data, the CPU 14 determines YES in S22. On the other hand, when the application data 58 is application data other than the first-type application, the CPU determines NO in S22.

When YES is determined in S22, the CPU 14 executes the first-type conversion program 26 to convert the application data 58 into the print data (S24). Specifically, the CPU 14 executes the first-type conversion program 26 to convert the data file 58 into coordinate data and then to convert the coordinate data into the print data (for example, PDL data). In S24, the CPU 14 generates the print data on the basis of printing conditions (such as sheet size and the number of colors to be printed) predetermined to correspond to the folder in which the data file 58 is stored. Subsequently, the CPU 14 supplies the print data to the print unit 36 (S26) and ends the flow of processes. The print unit 36 performs a printing operation using the supplied print data. On the other hand, when NO is determined in S22, the CPU 14 transmits a predetermined inquiry (B1) to the second printer 40 (S28). The CPU 14 inquires whether the CPU of the second printer 40 can convert the application data 58 into the print data. The inquiry (B1) includes information indicating the type of the application data 58.

When receiving the predetermined inquiry (B1) from the first printer 12, the CPU of the second printer 40 determines whether it can convert the application data 58 into the printer data (S42). The CPU of the second printer 40 determines that it can convert the application data when the application data 58 is the second-type application data, and determines that it cannot convert the application data when the application data is application data other than the second-type application data. The CPU of the second printer 40 transmits to the first printer 12 a response (B2), which includes the determination result, to the inquiry (B1) (S44).

When receiving the response (B2), the CPU 14 of the first printer 12 determines whether the second printer 40 can convert the application data 58 into the print data (S30). When NO is determined in S30, the CPU 14 transmits error information (A2) indicating that print is not possible to the PC 50 (S32) and ends the flow of processes. On the other hand, when YES is determined in S30, the CPU 14 transmits the data file 58 (B3) to the second printer 40 (S34). The CPU 14 transmits the printing conditions corresponding to the folder in which the data file 58 is stored to the second printer 40 along with the data file 58 (B3). Then, the CPU 14 transmits to the PC 50 destination information (A3) including information (such as a node name, an installation place, an IP address, and a MAC address of the second printer 40) for specifying the second printer 40 (S36) and ends the flow of processes.

When receiving the error information (A2) or the destination information (A3) from the first printer 12, the CPU 52 of the PC 50 displays the information on the display unit 68 (S16) and ends the flow of processes. On the other hand, when not receiving the information from the first printer 12 even in a predetermined time after transmitting the data file 58 in S12 (NO in S14), the CPU 52 skips S16 and ends the flow of processes.

When receiving the data file 58 (B3), the CPU of the second printer 40 converts the application data 58 into the print data (S46). In S46, the CPU of the second printer 40 generates the print data on the basis of the printing conditions transmitted from the first printer 12. Subsequently, the CPU of the second printer 40 supplies the print data to the print unit of the second printer 40 (S48) and ends the flow of processes. The print unit of the second printer 40 performs a printing operation using the supplied print data.

The communication system 10 according to this embodiment has been described in details. When receiving a print instruction from the PC 50, the first printer 12 determines whether it can convert application data into print data (S22 of FIG. 2). When it is determined that it cannot convert the application data (NO in S22 of FIG. 2), the first printer 12 inquires the second printer 40 whether it can convert the application data 58 into the print data (S28 of FIG. 2). When it is determined that the second printer 40 can convert the application data (YES in S30), the first printer 12 transmits the data file 58 to the second printer 40. The second printer 40 converts the application data 58 into the print data and performs a printing operation. According to this configuration, even when the first printer 12 cannot convert the data file 58 into the print data, the second printer 40 can convert the data file 58 into the print data. Even when the first printer 12 having received the print instruction from the PC 50 cannot convert the application data 58 into the print data, it is possible to convert the application data 58 into the print data by the use of the second printer 40.

When the printing operation is performed by the second printer 40, the first printer 12 transmits the destination information (A3 in FIG. 2) including the information of the second printer 40 to the PC 50 (S36 of FIG. 2). When receiving the destination information, the PC 50 displays the destination information on the display unit 68 (516 of FIG. 2). Accordingly, when the printer performing a printing operation is not the printer having received the print instruction, the user can easily see what printer to perform a printing operation.

### Second Embodiment

Differences from the first embodiment will be described. In a second embodiment, the first printer 12 inquires the second printer 40 about the type of application data which the second printer can convert into print data.

### Processes in Devices

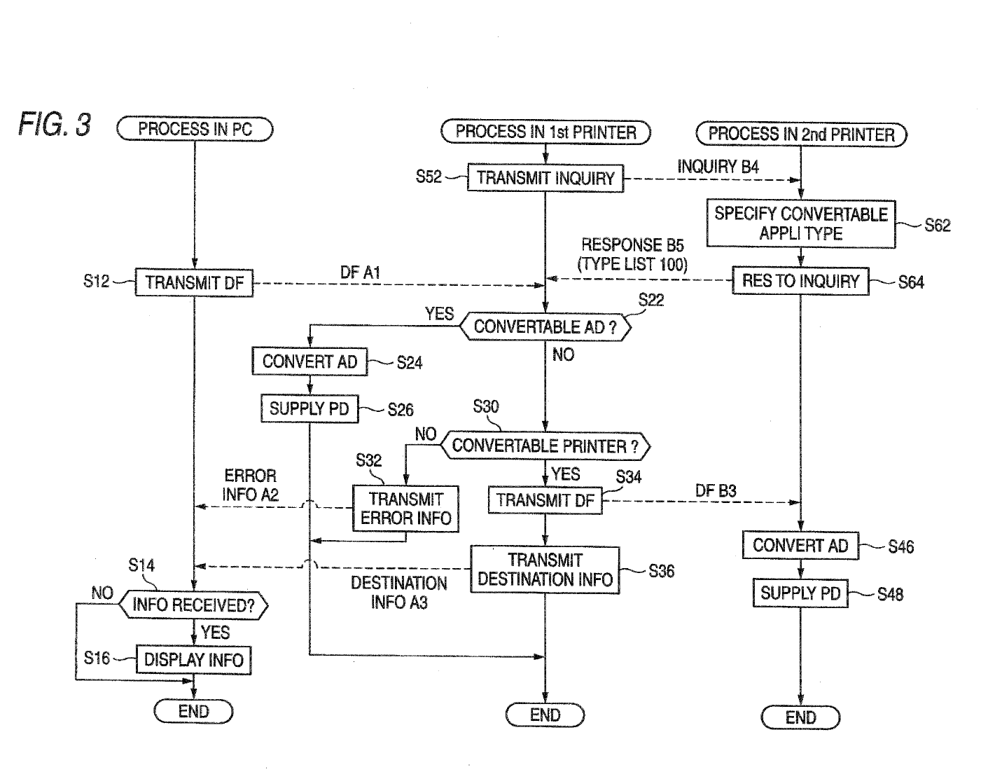

FIG. 3 is a flowchart illustrating flows of processes in the devices 12, 40, and 50 in this embodiment. In FIG. 3, the same processes as shown in FIG. 2 are referenced by the same reference signs as shown in FIG. 2.

The CPU 14 of the first printer 12 shown in FIG. 1 transmits a predetermined inquiry (B4) to the second printer 40 (S52). The CPU 14 inquires the types of application data which the CPU of the second printer 40 can convert into the print data which can be interpreted by the print unit of the second printer 20.

When receiving the predetermined inquiry (B4) from the first printer 12, the CPU of the second printer 40 specifies the types of application data which it can convert (S62). That is, the CPU of the second printer 40 specifies the types of the application data corresponding to the conversion program stored in the program storage area 42 (see FIG. 1). The CPU of the second printer 40 prepares a type list 100 in which the specified types (such as type names and extensions of application data) are described, and transmits the type list 100 to the first printer as a response (B5) to the inquiry (B4) (S64).

When receiving the response (B5) from the second printer 40, the CPU 14 of the first printer 12 stores the type list 100 in the storage unit 16. The CPU 14 periodically performs the process of S52 and updates the type list 100.

The CPU 14 of the first printer 12 determines whether it can convert the data file 58 into the print data (S22), and performs the process of S30 when NO is determined in S22. In S30, the CPU 14 determines whether the second printer 40 can convert the application data 58 into the print data using the type list 100 stored in the storage unit 16. For example, when the extension of the application data which can be converted by the second printer 40 is included in the type list 100, the CPU 14 determines whether the extension of the data file 58 is included in the type list 100. The CPU 14 determines YES in S30 when the extension of the data file 58 is included in the type list 100, and determines NO in S30 when the extension of the data file 58 is not included in the type list 100.

According to the configuration of the second embodiment, the same advantages as the first embodiment can be obtained. In the second embodiment, the first printer 12 acquires the type list 100 indicating the types of application data which can be converted into the print data by the second printer 40 before receiving the data file 58 from the PC 50, that is, before receiving the print instruction from the PC 50. The first printer 12 determines whether the second printer 40 can convert the application data 58 of the data file 58 received from the PC 50 into the print data using the type list when the CPU 14 cannot convert the data file 58 into the print data. According to this configuration, the CPU 14 need not inquire the second printer 40 whether the second printer 40 can convert the application data 58 into the print data after receiving the data file 58 from the PC 50. Accordingly, when the second printer 40 prints the images corresponding to the data file 58, it is possible to reduce the time from the print instruction to the end of print.

### Third Embodiment

Differences from the above-mentioned embodiments will be described. In the third embodiment, when the second printer 40 converts application data into print data, the print unit 36 of the first printer 12 performs a printing operation using the print data.

### Processes in Devices

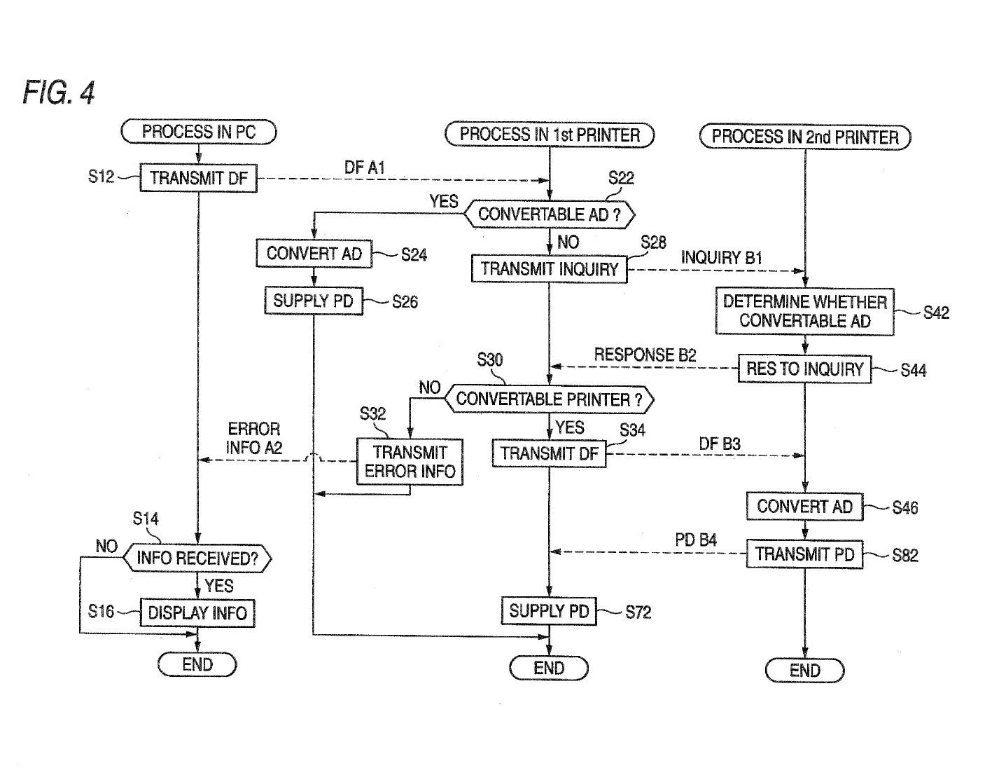

FIG. 4 is a flowchart illustrating flows of processes in the devices 12, 40, and 50 in this embodiment. In FIG. 4, the same processes as shown in FIG. 2 are referenced by the same reference signs as shown in FIG. 2.

In the third embodiment, the CPU 14 of the first printer 12 transmits the data file 58 (B3) to the second printer 40 (S34), but does not transmit the destination information (see A3 in FIG. 2) to the PC 50. When converting application data 58 of the data file 58 (B3) transmitted from the first printer 12 into the print data (S46), the CPU of the second printer 40 transmits the print data (B4) to the first printer 12 (S82).

When receiving the print data (B4) from the second printer 40, the CPU 14 of the first printer 12 supplies the print data (B4) to the print unit 36 (S72). The print unit 36 performs a printing operation using the print data.

According to the configuration of the third embodiment, the same advantages as the first embodiment can be obtained. In the third embodiment, the first printer 12 acquires the print data (B4) generated by the second printer 40 from the second printer 40 and performs a printing operation. Even when the second printer 40 generates the print data, the user can acquire the print result from the first printer 12 having instructed to perform the printing operation. The first printer 12 need not transmit the destination information to the PC 50.

As can be seen from the above description, the first printer 12, the second printer 40, and the PC 50 in these embodiments correspond to a first server, a second server, and a communication device, respectively. The processes S22, S24, S26, and S34 in FIG. 2 correspond to processes performed by a determination unit, a conversion unit, a print data supply unit, and an application data supply unit, respectively. The process of causing the first printer 12 to acquire the type list 100 in FIG. 3 corresponds to a process performed by an acquisition unit. The process of causing the first printer 12 to acquire the print data B4 in FIG. 4 corresponds to a process performed by a print data acquiring unit.

### MODIFIED EXAMPLES

(1) In the above-mentioned embodiments, the application program is stored in the program storage area 60 of the PC 50. However, the application program may not be stored in the PC 50. For example, the application program may be stored in an application server connected to the PC 50 via the LAN 80. The user of the PC 50 may generate the application data by accessing the application server using the PC 50 and causing the application server to execute the application program. In this case, the PC 50 serves as a viewer, but does not serve as a device for generating the application data. The function of the application server may be given to the printers 12 and 40.

(2) In the above-mentioned embodiments, the data file 58 is stored in the file storage area 56 of the PC 50. However, for example, the data file 58 may be stored in a data managing server connected to the PC 50 via the LAN 80. In other words, the data managing server may include the file storage area 56. The function of the data managing server may be given to the printers 12 and 40.

(3) The CPU 14, the storage unit 16, and the print unit 36 of the first printer 12 may be disposed separately from each other. That is, the communication system 10 may include a first converter (the first server) having the CPU 14 and the storage unit 16 and a first printer having the print unit 36. In this case, the first converter and the first printer may be connected to each other. via a network so as to communicate with each other. In this configuration, the first converter may supply the print data converted from the application data to the first printer. Similarly, the communication system 10 may include a second converter (the second server) having the CPU and the storage unit of the second printer 40 and a second printer having the print unit of the second printer 40. The communication system 10 may include the first converter, the second converter, and the first printer, but may not include the second printer. In this case, the first and second converters may supply the print data to the first printer.

(4) In the above-mentioned embodiments, the first-type conversion program 26 stored in the program storage area 24 of the first printer 12 is the same as the first-type application program 62 stored in the program storage area 60 of the PC 50, However, it suffices that the first-type conversion program 26 is a program causing the CPU 14 of the first printer 12 to convert the first-type application data into the print data. Similarly, it suffices that the second-type conversion program 44 is a program causing the CPU of the second printer 40 to convert the second-type application data into the print data. For example, the conversion programs may not have an editing function of the application program.

(5) In the second embodiment, the second printer 40 performs the printing operation when receiving the data file 58 from the first printer 12. However, the second printer 40 may convert the application data 58 into the print data and transmit the print data to the first printer 12, similarly to the third embodiment. In this case, the first printer 12 may perform a printing operation using the print data.

The technical elements described in the specification or shown in the drawings have the technical usefulness single or in various combinations and are not limited to the combinations described in the claims as filed. The techniques described in the specification or shown in the drawings accomplish plural objects together and have the technical usefulness even when they accomplish only one object.

What is claimed is:

1. A first server connectable to a communication device and a second server via a network, the first server comprising:
a conversion unit configured to convert application data generated by an application program into print data that can be interpreted by a printing unit;
a print data supply unit configured to supply the print data to the printing unit; and
a determination unit configured to, if the first server is instructed by the communication device to print an image indicated by specific application data generated by a specific application program, determine whether the conversion unit can convert the specific application data, wherein:
in a first case where the determination unit determines that the conversion unit can convert the specific application data, the conversion unit converts the specific application data into specific print data, and the print data supply unit supplies the specific print data to the print unit; and
the first server further comprises:
an application data supply unit configured to, in a second case where the determination unit determines that the conversion unit cannot convert the specific application data, supply the specific application data to the second server that can convert the specific application data.

2. The first server according to claim 1, wherein
the determination unit is further configured to determine whether the second server can convert the specific application data in the second case, and
the application data supply unit is configured to, if the determination unit determines that the second server can convert the specific application data, supply the specific application data to the second server.

3. The first server according to claim 2, wherein the determination unit is configured to determine whether the second server can convert the specific application data, by inquiring of the second server whether the second server can convert the specific application data.

4. The first server according to claim 2, wherein:
the first server further comprises an acquisition unit configured to acquire type information from the second server, the type information indicating types of application data that can be converted by the second server; and
the determination unit is configured to determine whether the second server can convert the specific application data on the basis of the acquired type information.

5. The first server according to claim 4, wherein the acquisition unit is configured to acquire the type information before the first server is instructed by the communication device to print the image indicated by the specific application data.

6. The first server according to claim 1, further comprising:
a print data acquiring unit configured to acquire the specific print data from the second server, the specific print data being generated by the second server executing the conversion of the specific application data,
wherein the print data supply unit is configured to supply the specific print data acquired by the print data acquiring unit to the printing unit.

7. A printer comprising:
a first server; and
a print unit, wherein:
the first server is connectable to a communication device and a second server via a network, and the first server comprises:
a conversion unit configured to convert application data generated by an application program into print data that can be interpreted by the printing unit;
a print data supply unit configured to supply the print data to the printing unit; and
a determination unit configured to, if the first server is instructed by the communication device to print an image indicated by specific application data generated by a specific application program, determine whether the conversion unit can convert the specific application data;
in a first case where the determination unit determines that the conversion unit can convert the specific application data, the conversion unit converts the specific application data into specific print data, and the print data supply unit supplies the specific print data to the print unit; and
the first server further comprises:
an application data supply unit configured to, in a second case where the determination unit determines that the conversion unit cannot convert the specific application data, supply the specific application data to the second server that can convert the specific application data.

8. A computer readable medium storing a program for configuring a computer to perform as a first server connectable to a communication device and a second server via a network, the first server comprising:
a conversion unit configured to convert application data generated by an application program into print data that can be interpreted by a printing unit;
a print data supply unit configured to supply the print data to the printing unit; and
a determination unit configured to, if the first server is instructed by the communication device to print an image indicated by specific application data generated by a specific application program, determine whether the conversion unit can convert the specific application data, wherein:
in a first case where the determination unit determines that the conversion unit can convert the specific application data, the conversion unit converts the specific application data into specific print data, and the print data supply unit supplies the specific print data to the print unit; and
the first server further comprises:
an application data supply unit configured to, in a second case where the determination unit determines that the conversion unit cannot convert the specific application data, supply the specific application data to the second server that can convert the specific application data.
